(19) United States
(12) Patent Application Publication
(10) Pub. No.: US 2024/0086824 A1
(43) Pub. Date: Mar. 14, 2024

(54) SYSTEM AND METHOD FOR DISTRIBUTION OF TEMPERATURE-SENSITIVE PRODUCTS

(71) Applicant: HDS Mercury, Inc., Palo Alto, CA (US)

(72) Inventor: Louis H. Borders, Portola Valley, CA (US)

(21) Appl. No.: 18/517,777

(22) Filed: Nov. 22, 2023

Related U.S. Application Data
(63) Continuation-in-part of application No. 17/319,747, filed on May 13, 2021.
Application No. 17/319,747 is a continuation-in-part of application No. 17/132,333, filed on Dec. 23, 2020.
(60) Provisional application No. 63/384,741, filed on Nov. 22, 2022.

(51) Int. Cl. G06Q 10/0832; B65D 1/34; B65D 8/00; B65D 25/06; G06Q 10/087

(52) U.S. Cl. CPC G06Q 10/0832; B65D 1/34; B65D 15/22; B65D 25/06; G06Q 10/087; B65D 2205/00

(57) ABSTRACT

A system for the distribution of temperature-sensitive products is described. The system may include one or more product trays for temperature-sensitive products. The system may include one or more mobile cabinets which includes a cabinet frame, a mobility mechanism, and at least one shelf for product trays. The system may include a conveyance system for transporting mobile cabinets from a distribution center to a point-of-sale location. The mobility mechanism can use an autonomous robot for moving mobile cabinets. The mobile cabinets are filled with product trays at the distribution center.

### CROSS REFERENCE TO RELATED APPLICATIONS

This application claims priority as a non-provisional to U.S. application Ser. No. 63/384,741, filed on Nov. 22, 2022, presently pending. This application is also a continuation in part of U.S. application Ser. No. 17/319,747, filed on May 13, 2021, presently pending. This application is also a continuation in part of U.S. application Ser. No. 17/132,333, filed on Dec. 23, 2020, presently pending. The contents of each application are hereby incorporated by reference.

### BACKGROUND OF THE INVENTION

### 1. Field of the Invention

This disclosure generally relates to a system and method of distribution of temperature-sensitive products. For example, in one embodiment, the system is used to distribute items requiring a cold chain.

### 2. Background of the Invention

Inventory at retail locations is generally delivered in large trucks, with a pallet load being one of the smallest units for delivery. Staff at the retail location must then unpack the delivery unit, transfer the inventory to a backroom storage location, and remove some inventory to the point-of-sale.

The maintenance of backroom storage is an inconvenience for both the operator of the retail location and the supplier. For the store operator, the backroom storage creates another space that must be optimized, and inventory of this area must be maintained with regular stock verifications. For the supplier, the small-scale backroom inventory locations become a bottleneck in the supply chain, as the limited amount of space and the lack of information about stock prevents being able to respond to changes in demand.

The process is inconvenient for temperature-sensitive products because each step must take place in a limited amount of time and in a temperature-controlled location. For example, for frozen foods, the steps of unloading, unpacking, placing in backroom storage, and moving to a retail location must all occur very quickly or in a freezer. In addition, frozen products must not be allowed to warm up above a safe temperature.

While the processes described below refer to frozen products being placed in freezers, the process is equally applicable to products that must be maintained at a constant temperature. For example, the system can also benefit pharmaceuticals or homeopathic medicines that must be kept in a narrow range of temperatures. Further, items that must be kept warm, such as prepared foods, can also use the system, except with a temperature-controlled heater instead of a freezer.

A need exists in the art for a system that can simplify the distribution of temperature-sensitive items. A need also exists for a system and method to distribute temperature-sensitive items. The system and method should simplify the process and allow for flexibility in responding to changes in demand.

### SUMMARY OF INVENTION

An object of the present invention is to provide a device and method for distributing temperature-sensitive products that overcome the drawbacks of state-of-the-art solutions.

Another object of the invention is to provide a system and method to distribute inventory to retail locations. A feature of this invention is that it allows for the distribution of limited quantities of inventory using product trays. A benefit of the invention is that it allows the distributor to respond to changes in demand.

Still, another object of the invention is to provide a device that allows for the distribution of temperature-controlled inventory. A feature of the invention is that the system includes distribution cabinets that maintain product trays within the required temperature range. A benefit of the invention is that inventory will remain in the required temperature range during the distribution process.

A further object of the invention is to provide a system that allows for rapid response to changes in demand. A feature of the invention is that distributors can respond to changes in demand by supplying retailers with additional inventory when needed. A benefit of the invention is that inventory is delivered to retail locations much more responsively.

Briefly, the techniques described herein relate to a system for the distribution of temperature-sensitive products; the system includes: at least one product tray adapted to receive temperature-sensitive products, at least one mobile cabinet including a cabinet frame, mobility mechanism, and at least one shelf adapted to receive the at least one product tray; a conveyance system for transporting said at least one mobile cabinet from a distribution center to the point-of-sale location; and wherein said mobility mechanism includes an autonomous robot for moving the at least one mobile cabinet to the point-of-sale; wherein said at least one mobile cabinet is filled with product trays at the distribution center.

### BRIEF DESCRIPTION OF THE DRAWINGS

The invention, together with the above and other objects and advantages, will be best understood from the following detailed description of the preferred embodiment of the invention shown in the accompanying drawings, wherein:

FIG. 1 is an overview of one embodiment of the system.

FIG. 2 shows the details of the product tray as used in one embodiment of the system.

FIG. 3 depicts the elements of the fulfillment system as used in one embodiment of the system.

FIG. 4 is a schematic overview of a warehouse implementing an embodiment of the fulfillment system.

FIG. 5 depicts an overview of an on-demand vehicle used in one system embodiment.

### DETAILED DESCRIPTION OF THE INVENTION

The foregoing summary and the following detailed description of certain embodiments of the present invention will be better understood when read in conjunction with the appended drawings.

As used herein, an element or step recited in the singular and proceeded with the word “a” or “an” should be understood as not excluding plural said elements or steps unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

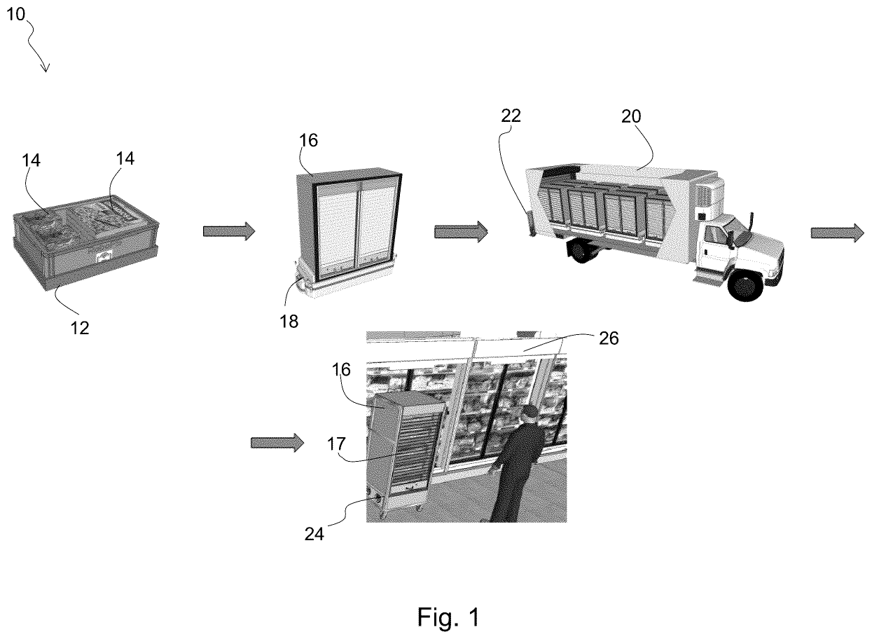

Turning to FIG. 1, depicted therein is an overview of an embodiment of the system; the embodiment is a temperature-controlled product handling system 10. In one implementation, the temperature-controlled products comprise frozen foods. The embodiment is a system for distribution from various source locations, such as manufacturers, warehouses, distribution centers, and others.

In some embodiments, the temperature-controlled products also comprise high-value products that must be tracked, and a complex cold chain must be maintained. For example, pharmaceutical products or components for pharmaceutical products are frequently sensitive to changes in temperature. A benefit of the temperature-controlled product handling system 10 is that it can address multiple categories of products without specialization. For example, the same components of the temperature-controlled product handling system 10 are used to prepare and convey pharmaceutical products in standard packaging (such as blister packs or bottles) without needing special pre-processing. Therefore, the temperature-controlled product handling system 10 is non-specialized in that it can handle products in boxes, bottles, bags, and other containers and can prepare some products for display in a retail location while other products are prepared for use in a non-retail environment (such as in a pharmacy).

The temperature-controlled product handling system 10 uses a series of product trays 12. Each product tray 12 includes a base and side walls which are used to contain individual products 14. The individual products 14 are held in packaging marked for retail sale in one embodiment so that customers can interact with the trays directly. The base of each product tray 12 includes reinforcement and a mechanism allowing the product tray 12 to interact with the remaining components of the temperature-controlled product handling system 10.

The product tray 12 can accommodate a variety of individual products 14. The individual products 14 can have a variety of dimensions or shapes, such as rectangular boxes for foods or cylindrical packaging for other temperature-sensitive items. In one embodiment, the base of the product tray includes a texture to prevent individual products 14 from shifting around the bottom of the product tray 12.

As shown in FIG. 1, each product tray 12 is placed in a mobile cabinet 16. As shown in FIG. 1, each mobile cabinet 16 includes a recloseable front panel such that temperatures within each mobile cabinet 16 remain controlled. As shown in FIG. 1, each mobile cabinet 16 includes a conveyance system for moving the mobile cabinet 16, such as an autonomous robotic mover 18, in one embodiment. The mobile cabinet 16 will therefore incorporate an interface for a robotic mover 18, including both hardware attachment and a means to exchange information with the robotic mover 18. In one embodiment, the exchange of information includes an identifier for the mobile cabinet 16. The autonomous robotic mover 18 monitors the location of each mobile cabinet 16 as well as ensures that the parameters of each mobile cabinet 16 remain within an acceptable range. For example, in one embodiment, each autonomous robotic mover 18 tracks the temperature of its assigned mobile cabinet 16 and accounts for the amount of time the mobile cabinet 16 has spent away from a temperature-controlled environment.

In one embodiment, the mobile cabinet 16 includes a number of visibility enhancing features for the interior of the mobile cabinet 16. In one embodiment, the front panel includes a transparent or translucent area and a motion detector, such that when motion in front of the mobile cabinet 16 is detected the interior of the mobile cabinet 16 is illuminated.

In turn, as shown in FIG. 1, the mobile cabinets 16 are placed into a vehicle 20, having a lift 22. The mobile cabinets 16 are placed on the vehicle 20 in the order they will be unloaded at destinations, thereby limiting the amount of time each mobile cabinet 16 has to spend outside of a controlled environment. As shown in FIG. 1, the vehicle 20 includes a temperature control system independent of the mobile cabinets 16, in one embodiment.

Upon arrival at a retail location, the mobile cabinet 16 is placed in a retail access point, such as a walk-up freezer 26 shown in FIG. 1. Prior to the installation of the mobile cabinet 16 in the retail access point, the robotic mover releases the mobile cabinet 16 and a standard rolling base 24 is revealed on the bottom of the mobile cabinet 16, and the front panel is opened. Customers can then access the mobile cabinet 16 at the walk-up freezer 26 or another temperature-controlled location and retrieve products from the product trays on at least one shelf 17 of the mobile cabinet 16.

As can be appreciated from FIG. 1, a benefit of the system is that the walk-up freezer can be restocked without manipulation of the temperature-controlled products by the employees of the retail location. The distributor has direct control over the quantities of products delivered to the retail location, and the restocking of the walk-up freezer 26 occurs instantly without having to access the back of the freezer, as is the case with conventional retail locations.

The system provides a number of benefits. For example, it allows for case-level fulfillment by delivering a mobile cabinet 16 to a location rather than a pallet of product that must be unloaded by employees. The system allows for just-in-time delivery as inventory levels are reviewed. The system avoids the problems of the deliveries not being frequent enough or the retail location experiencing an out-of-stock event. The system allows for the use of efficient warehouses and thus avoids expensive direct-to-store delivery. The system prevents unnecessary inventory handling from a warehouse to backroom storage to the retail point-of-sale. The system maintains a temperature control chain which has critical safety implications. The system prevents cardboard waste and allows retail locations to sell a wider variety of products in the temperature-controlled category.

The system increases sales by allowing the retail location to offer a wider variety of products. In addition, the system reduces labor by lowering the time employees have to devote to restocking, preventing spoilage, and eliminating unnecessary direct-to-store delivery.

Another benefit of the system is the modularity, with quantities of each component being optimized for the given application. For example, in a given retail establishment, a mobile cabinet 16 with fewer product trays 12 can be used, but providing more space between the product trays 12 for taller products 14. The use of the trays within the system allows for modular arrangements that are adapted for reconfiguration the storage space as needed to accommodate different products or quantities. For example, during warm months, the product trays are configured to store more grilling foods and picnic supplies, while during cooler months the trays are configured for foods cooked indoors.

### Product Trays

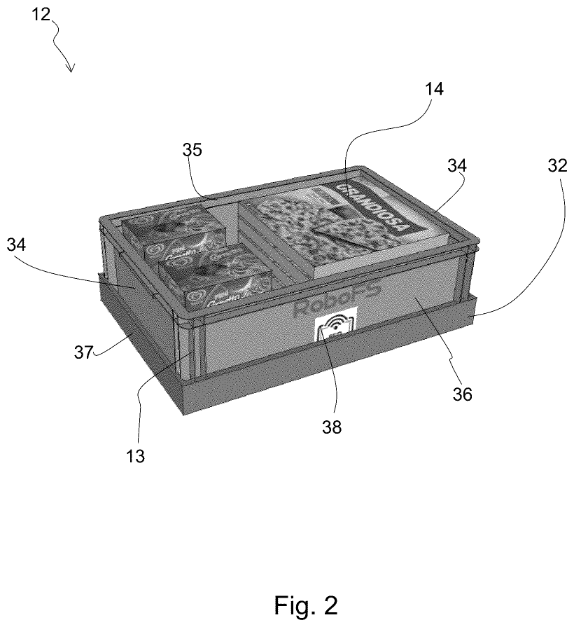

FIG. 2 shows the details of the product tray 12 for the individual products 14. Each product tray 12 comprises a base 32 and sidewalls 34. One of the sidewalls 34 is the front wall 36, which faces the consumer at a retail location. While in FIG. 2, the sidewalls 34 and the front wall 36 are shown as opaque, in one embodiment, at least the front wall 36 comprises a transparent material.

The front wall 36 includes at least one sensor in one embodiment. As shown in FIG. 2, the front wall 36 includes an identifier tag 38 as the sensor.

The base 32 is adapted to frictionally engage the shelves of the mobile cabinet (not shown in FIG. 2). In some embodiments, the base 32 also incorporates sensors to determine if the contents of the product tray 12 have changed, for example, by including a scale. In other embodiments, the sensors for determining changes to the product tray 12 are located in a central location, such as the mobile cabinet or in the retail location.

A benefit of the system is that the inventory of the product trays 12 can be correlated with the point-of-sale system of the retail location. The end customer can provide a desired quantity of products, and the system determines and identifies product trays 12 that are likely to run low on product.

One benefit of the product trays 12 is that the store employee can swap out the product tray 12 without having to touch or interact with the temperature-controlled products 14 located in the product trays 12. In one embodiment, the product trays 12 are filled with the products 14 while the delivery vehicle 20 remains in the range of both a warehouse facility and the retail location, allowing for nearly on-demand replenishment of products 14, as they are purchased at the retail location.

The product trays 12 are adapted for the point-of-sale display of temperature-sensitive products by comprising an attractive color scheme and incorporating a base that is received by the mobile cabinet 16 (shown in FIG. 1).

The product tray 12 shown in FIG. 2 can be manufactured from a number of plastic materials or can include metal components, such as metal reinforcement of the product tray exterior frame 13. In one embodiment, the product tray 12 base 32 comprises a different material from the product tray 12 sidewalls 34.

In one embodiment, the identifier tag 38 comprises an RFID tag. Further, in at least some embodiments, the identifier tag 38 includes one or more environmental sensors. For example, the identifier tag 38 includes a temperature-sensitive element in one embodiment, which changes the color of at least a part of the identifier tag 38 if the temperature of the product tray 12 exceeds acceptable ranges during transport. In another embodiment, the identifier tag 38 is an active tag that can be written to such that critical information about the product tray 12 is stored on the tray itself. Such critical information includes the packing date and expiration date, destination, a list of authorized retailers for that product tray 12, and other information. By providing the information on the identifier tag 38, the product tray 12 can be independently verified at various stages of the fulfillment system described below.

The product tray 12 includes a number of benefits with its design. In one embodiment, the product tray 12 includes a number of adjustable dividers, which allow the tray to accommodate and securely hold products of variable sizes. The dividers may include one or more bumpers or lips defined within the sidewalls 35 of the sidewalls 34 as shown in FIG. 2.

As can be appreciated from FIGS. 1 and 2, each product tray 12 frictionally engages with its shelf on the mobile cabinet 16 at the base 37 of the product tray 12, but nonetheless remains slidable and easy to fill both by automated systems described in this application as well as by end customers at a point-of-sale. As each product tray 12 is easily accessible, it encourages organization and improves convenience for the customers. In some embodiments, the base 37 includes one or more rollers to aid in the movement of the product tray 12, however, the base 37 comprises a non-slip material to prevent excess movement and potential falling out of the mobile cabinet 16.

In one embodiment, the product tray 12 comprises a hard plastic material for the sidewalls 34 and a different material for the base 37. The product tray 12 uses a durable material that is resistant to low temperatures and moisture, which is critical for longevity. The plastic material for the product tray 12 is also designed to be easy to clean which facilitates maintenance and prevents bacterial growth, especially important for distribution of temperature-sensitive food items, such as produce, meat, or dairy.

The base of the product tray 12 includes a number of air venting features such as vents to provide adequate ventilation, in one embodiment. Ventilation within each tray is important to maintain optimal airflow and preventing buildup of moisture.

As shown in FIG. 2, the product tray includes a number of safety features, such as an area on the front wall 36 for clear labeling, and rounded corners on the sidewalls 35. The elimination of sharp edges or other non-ergonomic features allow the product tray 12 to be used both in a commercial environment as well as by end-customers who may not be familiar with the product tray 12.

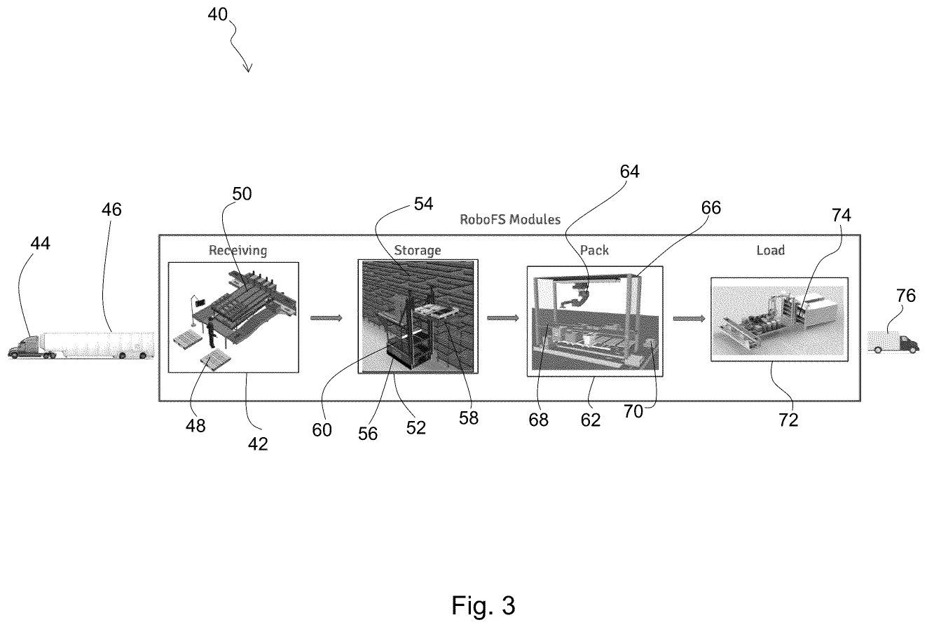

FIG. 3 depicts the elements of the fulfillment system 40, as used by the temperature-controlled product handling system 10. The fulfillment system 40 comprises multiple modules in one embodiment. While the modules are depicted in sequence in the overview of FIG. 3, it should be understood that each module operates in parallel and independently at certain times. However, the modules work cooperatively at other times of operation.

One module is the receiving module 42. The receiving module 42 comprises at least one means of receiving a payload from a large commercial vehicle 44, such as a large shipping container 46. The receiving module 42 will comprise unloading areas 48 and sorting areas 50. The receiving module 42 acts as a means to receive incoming products, generally provided at the receiving module 42 as a pallet of goods. In one embodiment, the sorting areas 50 are adapted to prioritize products, and so the sorting areas 50 systems determine which are in high demand and are to be repackaged and which products are to be stored in the inventory section of the facility.

Storage of inventory occurs in the storage module 52. The storage module 52 generally includes storage shelves 54 and at least one inventory management tool, such as a robotic frame 56 with inventory management tools 58. The robotic frame will also include temporary storage areas 60 to deliver inventory between shelves and between various modules.

Inventory is managed and packed in the packing module 62. The packing module 62 receives inventory from the storage module 52, in one embodiment and prepares shipments such as the product tray 12 shown in FIG. 2. As shown in FIG. 3, the packing module 62 includes a product selection arm 64 suspended in a moveable assembly 66 which interacts with products on various shelves 68, creating finished trays 70 by picking appropriate temperature-sensitive products.

The finished trays 70 are transferred to the loading module 72. The loading module 72 assembles the delivery packages 74. In one embodiment, the delivery packages 74 comprises mobile cabinets (such as mobile cabinet 16 shown in FIG. 1) which are placed on an on-demand delivery vehicle 76. As shown in FIG. 3, delivery packages 74 can comprise the payload of the on-demand delivery vehicle 76.

In one embodiment, the modules employ a robotic system, such as is described in the applicant's patent application titled “Modular Inventory Handling System and Method,” Ser. No. 17/319,747, currently pending. Transfer of products between modules may be accomplished by using the system described in the applicant's patent application “Machine to Machine Communications,” Ser. No. 17/187,181, currently pending, “Modular Inventory Handling System and Method,” Ser. No. 17/319,747, presently pending, “Mobile Robot Interactions Independent of Localization Data,” Ser. No. 17/132,333, presently pending. Several modules can benefit from system described in the applicant's patent “Shelving System and Power Transfer Device,” registered as U.S. Pat. No. 11,167,924 and the applicant's loader/unloader patent “Multiple Degree of Freedom Mobile Robot Loader-Unloader System and Method,” registered as U.S. Pat. No. 11,407,588 along with the “Robotic Frame and Power Transfer Device,” registered U.S. Pat. No. 10,065,798. The contents of each of which are hereby incorporated by reference.

Additional details of the modules are discussed herein.

A benefit of the fulfillment system 40 is that it is an end-to-end and highly automated system in some embodiments. The fulfillment system 40 can be used with a variety of applications, including e-commerce, warehouses, and automotive parts warehouses. While the fulfillment system 40 is described as being compatible with temperature-controlled products, it is similarly applicable to ambient systems.

Another benefit of the fulfillment system 40 is the creation of flexibility in the use of the on-demand delivery vehicle 76. While the large commercial vehicle 44 must be capable of hauling a container payload, the on-demand delivery vehicle 76 carries only delivery packages 74 having specific products and so the on-demand vehicle will be much smaller and can be an electric vehicle, or another type of low-emissions or fuel-efficient vehicle.

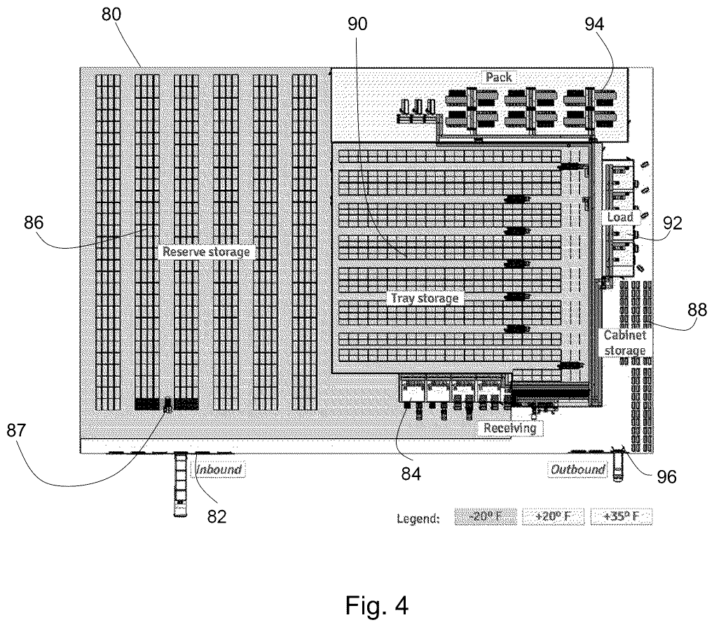

A schematic overview of a warehouse 80 implementing the fulfillment system 40 is shown in FIG. 4.

The warehouse 80 includes an inbound docking area 82 which is connected to a receiving system 84. Inventory from the receiving system 84 is transported to the reserve storage 86 and/or cabinet storage 88. In one embodiment, the reserve storage 86 incorporates an automated inventory management system 87, such as the one described in the applicant's prior application Ser. No. 17/132,333. That application describes a system of shelves and various inventory management tools, such as a mobile robots and mobile frames cooperatively moving inventory within the reserve storage 86 and also interacting with external inventory.

Limiting the number of workers required in the reserve storage 86 and the cabinet storage 88 areas includes a number of benefits. Workers in these cold areas experience discomfort and prolonged exposure to cold temperatures impacts overall health, which in turn means workers must wear cumbersome protective equipment which decreases dexterity and increases strain. The system as described herein obviates the need for routine interactions by workers in the coldest parts of the facility.

In-demand inventory is unloaded to the tray storage area 90 by the loading system 92. The loading system 92 also transfers tray storage area 90 inventory to the packing system 94, which assembles delivery payloads that are packaged and sent to the outbound area 96. An exemplary implementation of the loading system is found in the applicant's pending application describing a pick cell, Ser. No. 17/319,747, which is incorporated by reference as a parent patent application.

In the depicted embodiment, cabinet storage 88 is maintained in a temperature of +35 degrees Fahrenheit. The receiving system 84, the reserve storage 86, the tray storage area 90, the loading system 92, and other required areas are maintained at a temperature of −20 degrees Fahrenheit. The packing system 94 is maintained at a temperature of 20 degrees Fahrenheit.

A benefit of the warehouse 80 is that it maintains only those areas at a low temperature that are used for storage and not work. In the warehouse 80, as shown in FIG. 4, a storage area of 100000 square feet can be provided with few areas requiring in-person interaction with the inventory. This way, the inventory can be maintained at a low temperature without requiring workers to spend extensive time in low-temperature areas.

As shown in FIG. 4, the warehouse 80 supports as input a complete container on the receiving side, each container having pallets of products. The outbound inventory is presented for delivery to individual retail locations and includes item-level fulfillment and tracking as output.

The system as described herein allows for enhanced management of temperature-sensitive inventory from the warehouse to the point-of-sale. It maintains the reserve storage 86, the tray storage area 90, the receiving system 84 and the packing system 94 areas are all maintained at appropriate temperatures, with limited access by personnel (in some embodiments). A benefit of the system is that it prevents temperature fluctuations throughout the warehouse that could compromise the integrity of the products handled therein, without requiring extremely low temperatures, as is common in some prior art approaches. As such, by selecting and maintaining different optimum temperatures for each area, the system can save on energy costs.

A common challenge for temperature-sensitive products is that the products also have a limited lifespan. For example foods which require refrigeration will have a fixed sell-by date. The system as described herein will ensure that inventory is regularly rotated in and out of the reserve storage 86 to prevent waste. In one embodiment of the system, inventory includes the ability to trace and maintain accurate records of both temperature data and storage period for items, ensuring that items are not sold beyond their intended sell-by date and also that the lifespans of products are not diminished due to storage at incorrect temperatures.

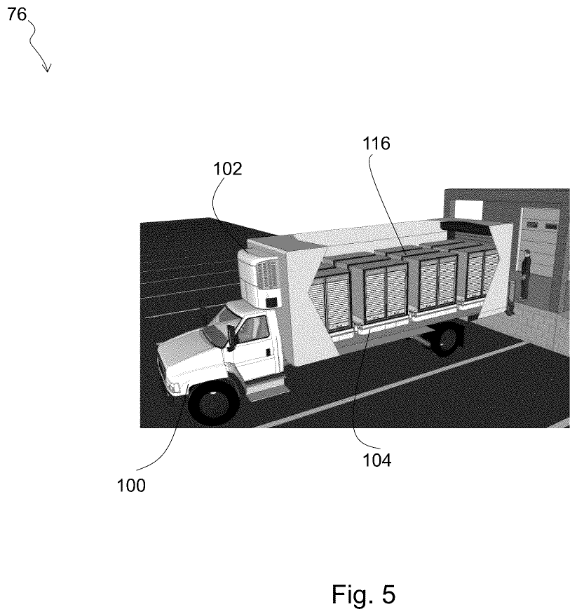

FIG. 5 depicts an overview of an on-demand delivery vehicle 76, in one embodiment. As shown in FIG. 5, the on-demand delivery vehicle 76 consists of a truck 100 with a temperature control system 102. The truck 100 receives mobile cabinets 116 with inventory (not visible). Each mobile cabinet 116 includes a movement mechanism 104, which is separable from the mobile cabinet 116. In one embodiment, the movement mechanism 104 comprises an autonomous robotic cabinet mover.

A benefit of the on-demand delivery vehicle 76 is that it facilitates fast delivery of individual mobile cabinets 116. The on-demand delivery vehicle 76 can serve more stores, have shorter routes, and provide frequent service. In one embodiment, the on-demand delivery vehicle 76 provides daily service to point-of-sale locations. In other embodiments, the on-demand delivery vehicle 76 dispatch system is in communication with the inventory system of each retail location, and the on-demand delivery vehicle 76 delivers fresh mobile cabinets 116 when the inventory level at a retail location exceeds the current supply.

As can be appreciated from the above description, the mobile cabinets 116 provide a number of benefits during the loading and unloading steps. The truck 100 can be fully loaded by moving a fixed quantity of mobile cabinets 116 into the truck 100. For example, in the embodiment shown in FIG. 5, the truck 100 carries twelve mobile cabinets 116, each having ten to twelve product trays (not visible in FIG. 5, but shown in FIG. 1). The operator of the truck 100 can drop off and pick up 150 product trays without having to actually handle any product trays.

As can be appreciated from the cut-away view of the truck 100, the mobile cabinets 116 are loaded on the truck in first-in-last-out order, and the order of delivery of the mobile carts is optimized for each stop on the delivery route of the truck 100. In one embodiment, the mobile cabinets 116 shift around inside of the truck at a delivery point once at least one of the mobile cabinets 116 closest to the truck 100 door is removed so that there is room for the empty cabinets and the subsequent mobile cabinet can be retrieved. In this way, movement mechanism 104 of each mobile cabinet 116 operates autonomously during the loading and unloading to facilitate retrieval of the following mobile cabinet 116.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting, but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

What is claimed is:

1. A system for distribution of temperature-sensitive products, the system comprising:
at least one product tray adapted to receive temperature-sensitive products;
at least one mobile cabinet comprising a cabinet frame, mobility mechanism, and at least one shelf adapted to receive the at least one product tray;
a conveyance system for transporting said at least one mobile cabinet from a distribution center to a point-of-sale location; and
wherein said mobility mechanism comprises an autonomous robot for moving the at least one mobile cabinet to the point-of-sale location;
wherein said at least one mobile cabinet is filled with product trays at the distribution center.

2. The system for distribution of temperature-sensitive products of claim 1, wherein said temperature-sensitive products comprise frozen foods.

3. The system for distribution of temperature-sensitive products of claim 1, wherein said product trays are adapted for display of the temperature-sensitive products at the point-of-sale location.

4. The system for distribution of temperature-sensitive products of claim 1, wherein said distribution center is adapted to fill the product trays using automated means.

5. The system for distribution of temperature-sensitive products of claim 4, wherein said distribution center is adapted to receive incoming products, store them in a temperature-sensitive location, pack and pick the temperature-sensitive products, and load them to the product trays.

6. The system for distribution of temperature-sensitive products of claim 5, wherein said incoming products comprise a load from a temperature-sensitive truck.

7. The system for distribution of temperature-sensitive products of claim 1, wherein said system accepts incoming pallets as input and distributes individual items in product trays as output.

8. The system for distribution of temperature-sensitive products of claim 1 wherein said conveyance system for transporting comprises a temperature-controlled truck containing at least one mobile cabinet.

9. The system for distribution of temperature-sensitive products of claim 1, wherein said point-of-sale location comprises a receiver for the at least one mobile cabinet.

10. The system for distribution of temperature-sensitive products of claim 9, wherein the receiver comprises a freezer and the at least one mobile cabinet is rolled into the freezer.

11. The system for distribution of temperature-sensitive products of claim 1, wherein said at least one product tray comprises dividers.

12. The system for distribution of temperature-sensitive products of claim 1, wherein said at least one product tray comprises a base.

13. The system for distribution of temperature-sensitive products of claim 12, wherein said at least one product tray base comprises a different material than the product tray.

14. The system for distribution of temperature-sensitive products of claim 1, wherein said at least one product tray comprises air venting features.

15. The system for distribution of temperature-sensitive products of claim 1, wherein said at least one product tray comprises rounded sidewalls.

16. The system for distribution of temperature-sensitive products of claim 1, wherein said distribution center comprises multiple types of storage.

17. The system for distribution of temperature-sensitive products of claim 16, wherein said distribution center types of storage comprises a reserve storage area, a cabinet storage area, and a tray storage area.

18. The system for distribution of temperature-sensitive products of claim 16, wherein said distribution center types of storage include different temperatures.

19. The system for distribution of temperature-sensitive products of claim 1, wherein said mobile cabinet further comprises an interface for a robotic mover to autonomously move the mobile cabinet.

20. The system for distribution of temperature-sensitive products of claim 1, wherein said mobile cabinet includes interior area visibility enhancing features.
